(19) United States
(12) Patent Application Publication
(10) Pub. No.: US 2012/0027896 A1
(43) Pub. Date: Feb. 2, 2012

(54) Fresh Meat Color in Vacuum Packaged or Modified Atmosphere Packaged Fresh Meat Products

(75) Inventors: John W. Summerfield, Austin, MN (US); Eric J. Holst, Dexter, MN (US); Nathan R. Smit, Brownsdale, MN (US)

(73) Assignee: HORMEL FOODS CORPORATION

(21) Appl. No.: 13/194,190

(22) Filed: Jul. 29, 2011

Related U.S. Application Data
(60) Provisional application No. 61/369,234, filed on Jul. 30, 2010.

(51) Int. Cl. A23L 1/31; A23B 4/14; B65B 25/06

(52) U.S. Cl. 426/129; 426/281

(57) ABSTRACT

A packaged treated fresh meat product comprises a fresh meat product, a solution, and a low to no oxygen packaging. The solution includes a source of sodium nitrite or sodium nitrate infused into the fresh meat product to create a treated fresh meat product. The low to no oxygen packaging contains the treated fresh meat product, wherein the treated fresh meat product has a fresh meat color before cooking and a uniform, uncured cooked color after cooking to done.

This application claims the benefit of U.S. Provisional Patent Application Ser. No. 61/369,234, filed Jul. 30, 2010, which is herein incorporated by reference.

### FIELD OF THE INVENTION

The present invention relates to fresh meat color in vacuum packaged or modified atmosphere packaged fresh meat products.

### BACKGROUND

Fresh meat products are commonly placed in vacuum packages or modified atmosphere packages to assist in prolonging the shelf-life of the fresh meat products. Vacuum packaged fresh meat products can appear dull and grey in color. If the modified atmosphere packages do not contain a gas such as carbon monoxide to improve or stabilize the color of the fresh meat products, the fresh meat products can also appear dull and grey in color.

Consumers typically purchase fresh meat products based upon their appearance, both before and after cooking the fresh meat products. It is important to have a fresh, raw meat color before cooking the fresh meat products and a uniform, uncured color after cooking the fresh meat products to done.

For the reasons stated above and for other reasons stated below, which will become apparent to those skilled in the art upon reading and understanding the present specification, there is a need in the art for a fresh meat color before cooking fresh meat products and a uniform, uncured color after cooking fresh meat products to done.

### SUMMARY

The above-mentioned problems associated with prior devices are addressed by embodiments of the present invention and will be understood by reading and understanding the present specification. The following summary is made by way of example and not by way of limitation. It is merely provided to aid the reader in understanding some of the aspects of the invention.

In one embodiment, a packaged treated fresh meat product comprises a fresh meat product, a solution, and a low to no oxygen packaging. The solution includes a source of sodium nitrite or sodium nitrate infused into the fresh meat product to create a treated fresh meat product. The low to no oxygen packaging contains the treated fresh meat product, wherein the treated fresh meat product has a fresh meat color before cooking and a uniform, uncured cooked color after cooking to done.

In another embodiment, a packaged treated fresh pork product comprises a fresh pork product, a solution, and a low to no oxygen packaging. The solution includes a source of sodium nitrite or sodium nitrate infused into the fresh pork product to create a treated fresh pork product, and the solution includes 0.1 to 10.0 ppm of the source of sodium nitrite or sodium nitrate. The low to no oxygen packaging contains the treated fresh pork product, wherein the treated fresh pork product has a fresh meat color before cooking and a uniform, uncured cooked color after cooking to done.

In another embodiment, a packaged treated fresh beef product comprises a fresh beef product, a solution, and a low to no oxygen packaging. The solution includes a source of sodium nitrite or sodium nitrate infused into the fresh beef product to create a treated fresh beef product, and the solution includes 1.0 to 20.0 ppm of the source of sodium nitrite or sodium nitrate. The low to no oxygen packaging contains the treated fresh beef product, wherein the treated fresh beef product has a fresh meat color before cooking and a uniform, uncured cooked color after cooking to done.

In another embodiment, a method of treating a fresh meat product comprises obtaining a fresh meat product selected from the group consisting of a pork product, a beef product, a poultry product, a lamb product, a fish product, and a seafood product. The fresh meat product is infused with a solution including a source of sodium nitrite or sodium nitrate to create a treated fresh meat product, and the treated fresh meat product is packaged in a low to no oxygen packaging, wherein the treated fresh meat product has a fresh meat color before cooking and a uniform, uncured cooked color after cooking to done.

### BRIEF DESCRIPTION OF THE DRAWINGS

The present invention can be more easily understood, and further advantages and uses thereof can be more readily apparent, when considered in view of the detailed description and the following Figures in which:

FIG. 1 is a schematic view of a whole loin;

FIG. 2 is a schematic view of a chop;

FIG. 3 is a graph showing Minolta color scores for L* for raw chops treated with solutions including five different levels of a product for a first replicate experiment over a period of days;

FIG. 4 is a graph showing Minolta color scores for L* for cooked chops treated with solutions including five different levels of a product for a first replicate experiment over a period of days;

FIG. 5 is a graph showing Minolta color scores for L* for raw chops treated with solutions including five different levels of a product for a second replicate experiment over a period of days;

FIG. 6 is a graph showing Minolta color scores for L* for cooked chops treated with solutions including five different levels of a product for a second replicate experiment over a period of days;

FIG. 7 is a graph showing Minolta color scores for L* for raw chops treated with solutions including five different levels of a product for a third replicate experiment over a period of days;

FIG. 8 is a graph showing Minolta color scores for L* for cooked chops treated with solutions including five different levels of a product for a third replicate experiment over a period of days;

FIG. 9 is a graph showing Minolta color scores for a* for raw chops treated with solutions including five different levels of a product for a first replicate experiment over a period of days;

FIG. 10 is a graph showing Minolta color scores for a* for cooked chops treated with solutions including five different levels of a product for a first replicate experiment over a period of days;

FIG. 11 is a graph showing Minolta color scores for a* for raw chops treated with solutions including five different levels of a product for a second replicate experiment over a period of days;

FIG. 12 is a graph showing Minolta color scores for a* for cooked chops treated with solutions including five different levels of a product for a second replicate experiment over a period of days;

FIG. 13 is a graph showing Minolta color scores for a* for raw chops treated with solutions including five different levels of a product for a third replicate experiment over a period of days;

FIG. 14 is a graph showing Minolta color scores for a* for cooked chops treated with solutions including five different levels of a product for a third replicate experiment over a period of days;

FIG. 15 is a graph showing Minolta color scores for b* for raw chops treated with solutions including five different levels of a product for a first replicate experiment over a period of days;

FIG. 16 is a graph showing Minolta color scores for b* for cooked chops treated with solutions including five different levels of a product for a first replicate experiment over a period of days;

FIG. 17 is a graph showing Minolta color scores for b* for raw chops treated with solutions including five different levels of a product for a second replicate experiment over a period of days;

FIG. 18 is a graph showing Minolta color scores for b* for cooked chops treated with solutions including five different levels of a product for a second replicate experiment over a period of days;

FIG. 19 is a graph showing Minolta color scores for b* for raw chops treated with solutions including five different levels of a product for a third replicate experiment over a period of days; and

FIG. 20 is a graph showing Minolta color scores for b* for cooked chops treated with solutions including five different levels of a product for a third replicate experiment over a period of days.

In accordance with common practice, the various described features are not drawn to scale but are drawn to emphasize specific features relevant to the present invention. Reference characters denote like elements throughout the Figures and the text.

### DETAILED DESCRIPTION OF A PREFERRED EMBODIMENT

In the following detailed description, embodiments in which the inventions may be practiced are described in sufficient detail to enable those skilled in the art to practice the invention, and it is to be understood that other embodiments may be utilized and mechanical changes may be made without departing from the spirit and scope of the present invention. The following detailed description is, therefore, not to be taken in a limiting sense, and the scope of the present invention is defined only by the claims and equivalents thereof.

An embodiment of the present invention includes injecting or otherwise infusing a solution including sodium nitrite or sodium nitrate or a natural source of sodium nitrite or sodium nitrate into a fresh meat product and then packaging the injected or infused fresh meat product in a package including low to no oxygen such as a vacuum package or a modified atmosphere package. Although any suitable package could be used, it is preferred that the packaged, injected or infused fresh meat product includes low to no oxygen. Low to no oxygen is preferably 0% to 1.0% oxygen of any volume of gases in the package. For a modified atmosphere package, it is recognized that any suitable combination of gases in suitable ranges of percentages could be used. The injected or infused fresh meat product could optionally also be vacuum tumbled prior to packaging to assist in evenly distributing the sodium nitrite or sodium nitrate or natural source of sodium nitrite or sodium nitrate throughout the meat product.

Examples of types of fresh meat products that could be used include, but are not limited to, pork products, beef products, poultry products, lamb products, and other fresh meat products. Other fresh meat products could include fish products and seafood products.

The solution could be injected into the meat with needle injections, which give a good distribution of the solution into the meat. Although the solution is preferably injected into the meat with needles, any suitable method of injecting or otherwise infusing the meat with good distribution of the solution in the meat could be used. The solution could be infused into the meat using vacuum tumbling or immersion.

The solution could include sodium nitrite or sodium nitrate or a natural source of sodium nitrite or sodium nitrate dissolved in water. If nitrate is used, it is converted to nitrite by fermentation as is well known in the art. The source of the sodium nitrite or sodium nitrate is preferably a natural source such as, but not limited to, vegetable powders. An example of a natural source of sodium nitrite or sodium nitrate that could be used is VEG STABLE™ 504, manufactured by Florida Food Products, Inc. of Eustis, Florida, or other vegetable based ingredients containing nitrites or fermented nitrates. Other ingredients such as, but not limited to, salt, sodium tri-polyphosphate (hereinafter “STPP”), potassium lactate, sodium diacetate, and dextrose could be included in the solution. For ease of reference, any reference herein to sodium nitrite or sodium nitrate also includes a natural source of sodium nitrite or sodium nitrate and any reference to nitrite includes sodium nitrite or sodium nitrate or a natural source of sodium nitrite or sodium nitrate.

After the fresh meat product is infused with a solution including a source of sodium nitrite or sodium nitrate to create a treated fresh meat product, the treated fresh meat product is packaged in a low to no oxygen packaging, which preferably includes 0% to 1.0% oxygen of any volume of gases in the package. Within up to approximately 3 days of injecting a fresh meat product with a solution including sodium nitrite or sodium nitrate or a natural source of sodium nitrite or sodium nitrate, the solution penetrates and is dispersed throughout a majority of the meat product, resulting in a bloomed meat color, so that the color of the meat product is generally a fresh, raw meat color before cooking and a uniform, uncured color after the meat is cooked to done, and the injected meat product is not cured. Generally, cooked to done means the United States Department of Agriculture (“USDA”) recommended safe minimum internal temperature. For example, for pork and beef products, cooked to done means an internal temperature of approximately 145 to 160° F. The sodium nitrite or sodium nitrate or natural source of sodium nitrite or sodium nitrate assists in stabilizing the color of the meat product and may assist in lengthening the shelf-life of the meat product.

The levels of sodium nitrite or sodium nitrate or natural source of sodium nitrite or sodium nitrate depend upon the amount of myoglobin in the meat, which could depend upon the type of meat, the quality of the meat, the cut of meat, the age of the animal, and other factors well known in the art. If too little sodium nitrite or sodium nitrate is used, then the fresh meat will not have the desired fresh pink or red color in the absence of oxygen. For pork products, a fresh meat color is pink. For beef products, a fresh meat color is red. If too much sodium nitrite or sodium nitrate is used, the meat will stay pink in color after cooking, much like a cured meat. For pork, the sodium nitrite or sodium nitrate concentration should be 0.1 to 10.0 ppm, more preferably 2.0 to 5.0 ppm. For beef, the sodium nitrite or sodium nitrate concentration should be 1.0 to 20.0 ppm, more preferably 2.0 to 10.0 ppm.

If the treated fresh meat product is also vacuum tumbled, it is preferably tumbled for 5 to 30 minutes at 1 to 30 rpm under a vacuum of approximately 15 to 30 inches Hg.

The treated fresh meat is packaged in a low to no oxygen packaging such as vacuum packaging or modified atmosphere packaging. At least several advantages of vacuum packaging are less expensive packaging materials, ease of shipping and handling, ease of storage, less bacteria growth, less freezer burn, and longer shelf-life and storage. Those skilled in the art will recognize other advantages to vacuum packaging and will recognize advantages to modified atmosphere packaging.

### Example 1

Three fresh pork loins were obtained. Each fresh pork loin was cut into two portions, one portion being a control portion and the other portion being a treated portion.

A sodium nitrite solution was made. The sodium nitrite solution included 0.0972 grams of sodium nitrite and 453.5 grams of water, 0.02% sodium nitrite and 99.98% water. A volume of the sodium nitrite solution was sprayed into a vacuum bag containing a loin portion to be treated prior to sealing the vacuum bag. The solution was targeted for an overall 3 ppm sodium nitrite level in the loin. This was based on an 8 pound weight of the loin portion and 50 mL of solution sprayed into the vacuum bag.

Three different volumes of solution were used and water was used to make up the balance of the solution to total 50 mL. Sample A included 50 mL of solution, Sample B included 25 mL of solution and 25 mL of water, and Sample C included 12.5 mL solution and 37.5 mL of water. Each Sample had a corresponding control without any solution to which the color of the corresponding Sample was compared.

After the Samples were treated, the treated Samples including sodium nitrite first turned darker in color than the corresponding controls later that same day. The next day, the treated Samples including sodium nitrite were brighter in color than the corresponding controls. The Minolta color scores were as follows:

TABLE 1
Minolta Color Scores for Samples and Corresponding Controls

| Minolta | | Control | | Control | | Control |
|---|---|---|---|---|---|---|
| Color | Sample A | A | Sample B | B | Sample C | C |
| L* | 56.37 | 54.36 | 55.97 | 56.26 | 49.47 | 46.87 |
| a* | 7.70 | 5.34 | 6.70 | 5.06 | 4.28 | 3.45 |
| b* | 4.37 | 1.42 | 3.25 | 0.91 | 1.25 | −0.72 |

The treated Samples were cut, and the sodium nitrite solution penetrated the loins ½ to 1 inch through the loins and the centers of the loins were not affected. The sodium nitrite solution penetrated portions of the loins appeared pinker in color than the center, non-penetrated portions. Thus, the treated Samples had a two-toned appearance.

The treated Samples were also cooked, and there was a definite difference between the sodium nitrite solution penetrated portions and the center, non-penetrated portions of the loins. The cooked, treated Samples also appeared two-toned, which was not aesthetically pleasing.

Although an initial color of the loins was acceptable, after a period of time, the loins appeared two-toned in color. Therefore, it was determined that spray application of the solution was not acceptable.

### Example 2

A solution including water, salt, STPP, potassium lactate, sodium diacetate, and VEG STABLE™ 504, manufactured by Florida Food Products, Inc. of Eustis, Florida was made. The solution included amounts of ingredients as follows:

TABLE 2
Solution Formulation

| | Pounds per 110 | Percent in | |
|---|---|---|---|
| Ingredient | Pounds of Pickle | Pickle | Percent in Product |
| Water | 89.11571 | 81.0143 | 10.1268 |
| Salt | 2.64 | 2.4000 | 0.3000 |
| STPP | 3.928571 | 3.5714 | 0.4464 |
| Potassium Lactate | 13.2 | 12.0000 | 1.5000 |
| Sodium Diacetate | 0.88 | 0.8000 | 0.1000 |
| VEG STABLE ™ | 0.235714 | 0.2143 | 0.0268 |
| 504 | | | |

Seven pork loins were cut in half, one half was to be used as a treated portion and the other half was to be used as a control portion. The treated portions included VEG STABLE™ 504 and the control portions did not include VEG STABLE™ 504. The treated portions were injected with the solution at 14% to yield, after purge loss, 112% from starting weight or 12% over green weight. The rib ends were alternated as treated portions and control portions to make sure the rib ends did not affect the test. This was done because the loins were not symmetrical so the rib ends were alternated to take out this asymmetrical affect. The treated loins were also cut into chops, and the chops were placed in vacuum packaging and low oxygen packaging. The low oxygen packaging included approximately 40% carbon dioxide and 60% nitrogen. The treated loins first went through a darkening stage and then lightened up and became much brighter in color than the corresponding controls.

This test was also conducted on a beef strip loin, which was cut in half, and one half was a treated portion and the other half was a control portion.

From these tests, it was determined that there was better uniform, uncured color both in the raw and cooked to done states of the treated meat products.

### Example 3

VEG STABLE™ 504 was incorporated into a brine solution, and the solution was injected into pork loins and beef loins at 12% over green weight. VEG STABLE™ 504 was used at 0.25% of the brine solution. The pork and beef loins were cut in half, one half being the treated portion and the other half being the control portion. The treated portions were divided and packaged in vacuum packaging, modified atmosphere packaging including 40% carbon dioxide and 60% nitrogen, and overwrap. The control portions were divided and packaged in vacuum packaging, modified atmosphere packaging including 40% carbon dioxide and 60% nitrogen, and overwrap.

Generally, all of the treated pork and beef loins in all of the packaging applications, except for day 1 of the overwrap packaging, turned pinkish-red in color. The color was uniform and uncured throughout the meat products. More specifically, the pork loins and chops turned pinkish-red in the vacuum packaging and in the modified atmosphere packaging. The chops placed in the overwrap did not change color. The beef loins and steaks turned pinkish-red in the vacuum packaging and in the modified atmosphere packaging, however, the color was not as intense as in the pork loins and chops.

From this test, it was determined that VEG STABLE™ 504 may be used to stabilize the color of vacuum packaged and modified atmosphere packaged meat products without the use of carbon monoxide.

### Example 4

This test was conducted to evaluate the effect of different low levels of a product on color stability in vacuum packaged fresh pork over 30 days. The experimental design was a randomized complete block design and was blocked by loin.

Five different levels of product, VEG STABLE™ 504, in solutions were tested. The levels of product in the solutions were 0 ppm, 2 ppm, 4 ppm, 6 ppm, and 8 ppm. The solutions included ingredients as follows:

TABLE 3
Formulation for Solution Including 0 ppm Product

| | Pounds per 100 | Percent | |
|---|---|---|---|
| Ingredient | Pounds of Pickle | in Pickle | Percent in Product |
| Water | 83.50313 | 83.5031 | 9.0071 |
| Salt | 1.854167 | 1.8542 | 0.2000 |
| STPP | 4.166667 | 4.1667 | 0.4494 |
| Potassium Lactate | 9.270833 | 9.2708 | 1.0000 |
| Sodium Diacetate | 1.205208 | 1.2052 | 0.1300 |

TABLE 4
Formulation for Solution Including 2 ppm Product

| | Pounds per 100 | Percent | |
|---|---|---|---|
| Ingredient | Pounds of Pickle | in Pickle | Percent in Product |
| Water | 83.33646 | 83.3365 | 8.9891 |
| Salt | 1.854167 | 1.8542 | 0.2000 |
| STPP | 4.166667 | 4.1667 | 0.4494 |
| Potassium Lactate | 9.270833 | 9.2708 | 1.0000 |
| Sodium Diacetate | 1.205208 | 1.2052 | 0.1300 |
| VEG STABLE ™ | 0.166667 | 0.1667 | 0.0180 |
| 504 | | | |

TABLE 5
Formulation for Solution Including 4 ppm Product

| | Pounds per 100 | Percent | |
|---|---|---|---|
| Ingredient | Pounds of Pickle | in Pickle | Percent in Product |
| Water | 83.16979 | 83.1698 | 8.9711 |
| Salt | 1.854167 | 1.8542 | 0.2000 |
| STPP | 4.166667 | 4.1667 | 0.4494 |
| Potassium Lactate | 9.270833 | 9.2708 | 1.0000 |
| Sodium Diacetate | 1.205208 | 1.2052 | 0.1300 |
| VEG STABLE ™ | 0.333333 | 0.3333 | 0.0360 |
| 504 | | | |

TABLE 6
Formulation for Solution Including 6 ppm Product

| | Pounds per 100 | Percent | |
|---|---|---|---|
| Ingredient | Pounds of Pickle | in Pickle | Percent in Product |
| Water | 83.003125 | 83.0031 | 8.9531 |
| Salt | 1.85416667 | 1.8542 | 0.2000 |
| STPP | 4.16666667 | 4.1667 | 0.4494 |
| Potassium Lactate | 9.27083333 | 9.2708 | 1.0000 |
| Sodium Diacetate | 1.20520833 | 1.2052 | 0.1300 |
| VEG STABLE ™ | 0.5 | 0.5000 | 0.0539 |
| 504 | | | |

TABLE 7
Formulation for Solution Including 8 ppm Product

| | Pounds per 100 | Percent | |
|---|---|---|---|
| Ingredient | Pounds of Pickle | in Pickle | Percent in Product |
| Water | 82.836458 | 82.8365 | 8.9352 |
| Salt | 1.8541667 | 1.8542 | 0.2000 |
| STPP | 4.1666667 | 4.1667 | 0.4494 |
| Potassium Lactate | 9.2708333 | 9.2708 | 1.0000 |
| Sodium Diacetate | 1.2052083 | 1.2052 | 0.1300 |
| VEG STABLE ™ | 0.6666667 | 0.6667 | 0.0719 |
| 504 | | | |

Ten randomly chosen loins were tested for each replicate experiment, and there were three replicate experiments. The pH of each whole loin chunk was measured prior to injecting it with one of the solutions, and there were no significant differences in pH. All of the whole loin chunks were injected at approximately 12% over green weight. A small core was taken from each whole loin chunk and analyzed for product after being injected.

A whole loin chunk 10 is shown schematically in FIG. 1. The whole loin chunk 10 was divided into five experimental units 11a, 11b, 11c, 11d, and 11e. The solid lines 12 represent where the whole loin chunk 10 could be cut to create the experimental units. Each experimental unit was then divided into five chops. The dashed lines 13 represent where the experimental unit 11d could be cut to create the chops. The other experimental units could be similarly cut. Of the five chops, two chops were used for nitrite analysis and three chops were used for color analysis.

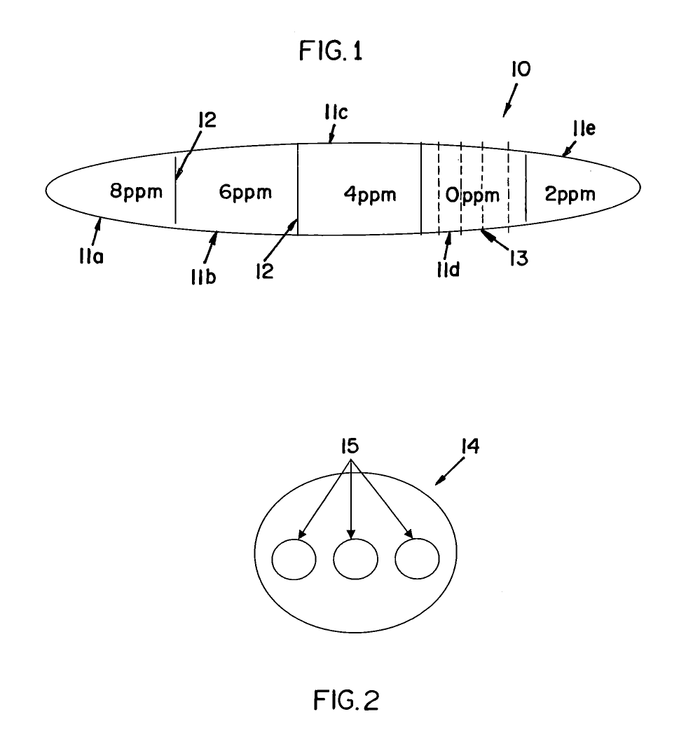

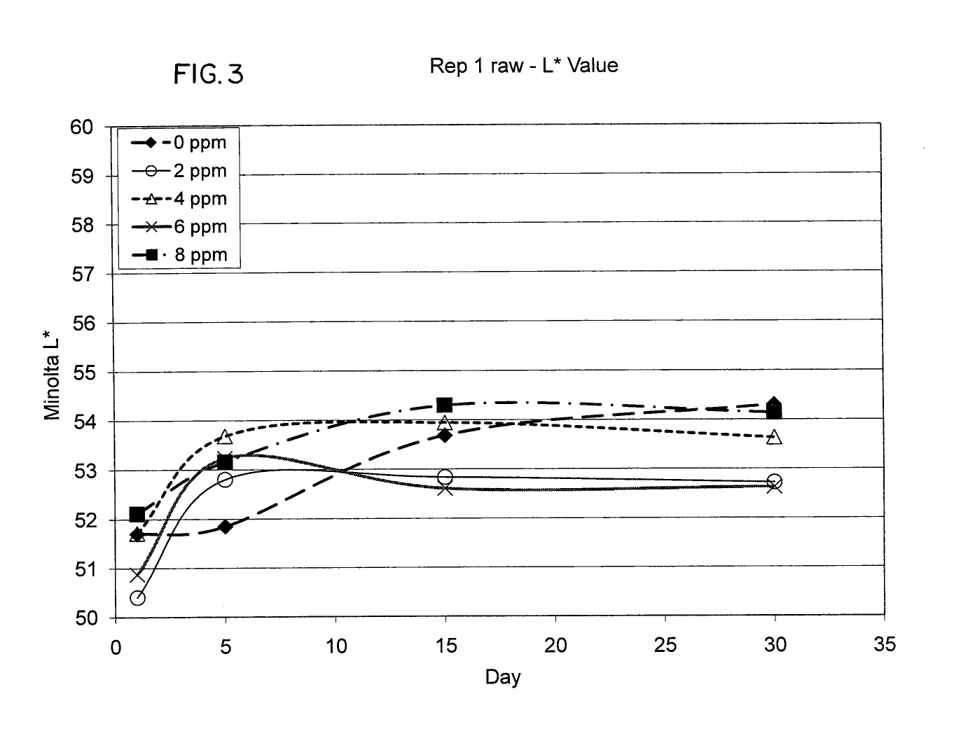

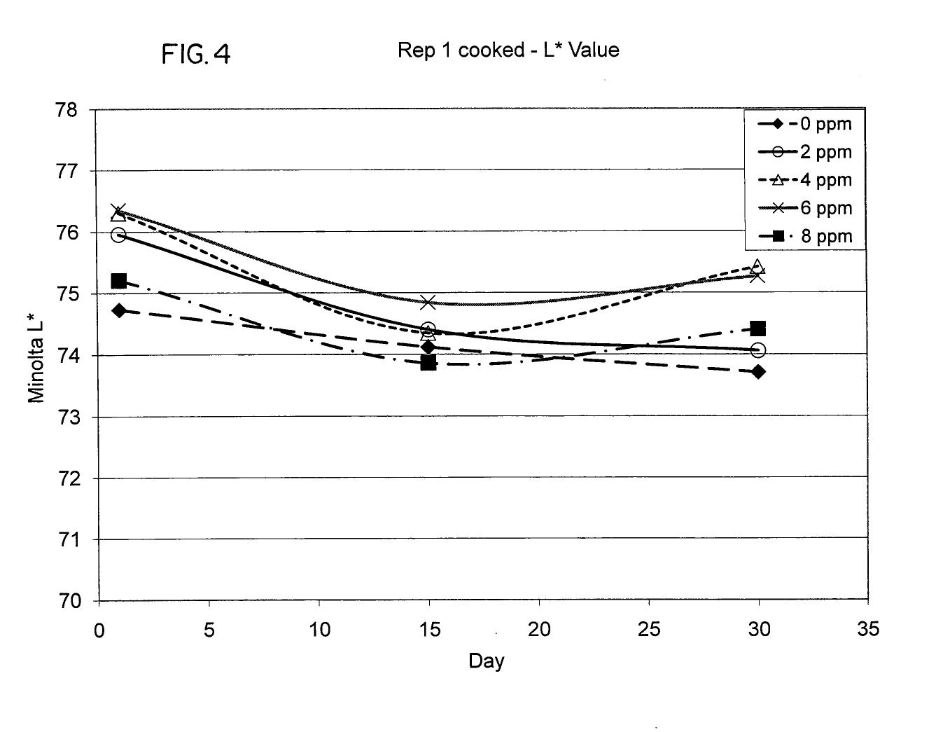

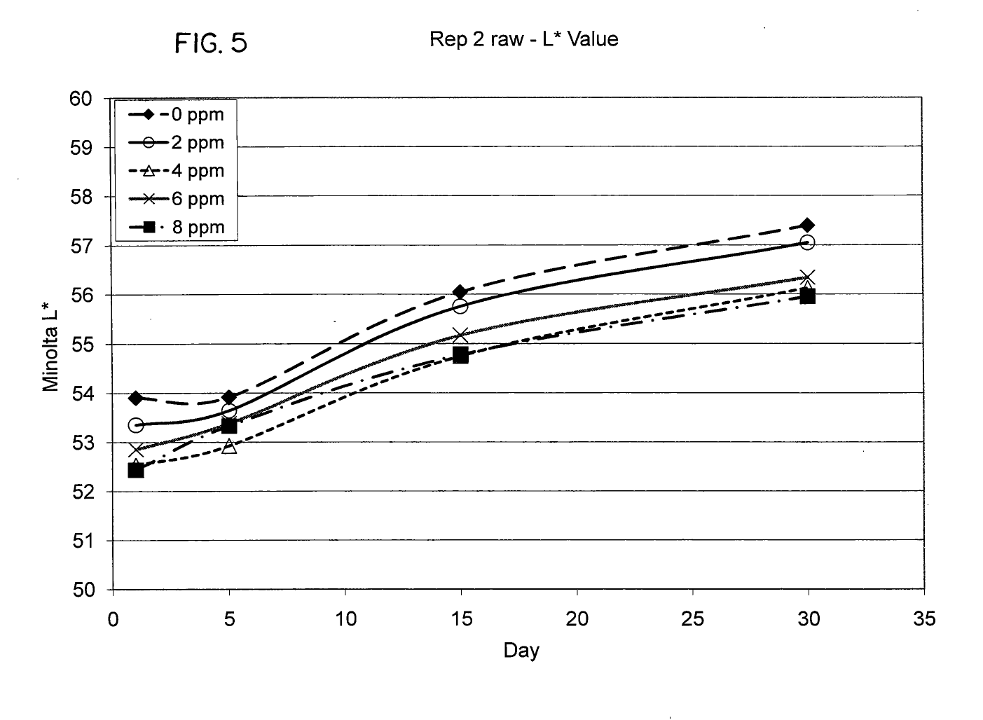

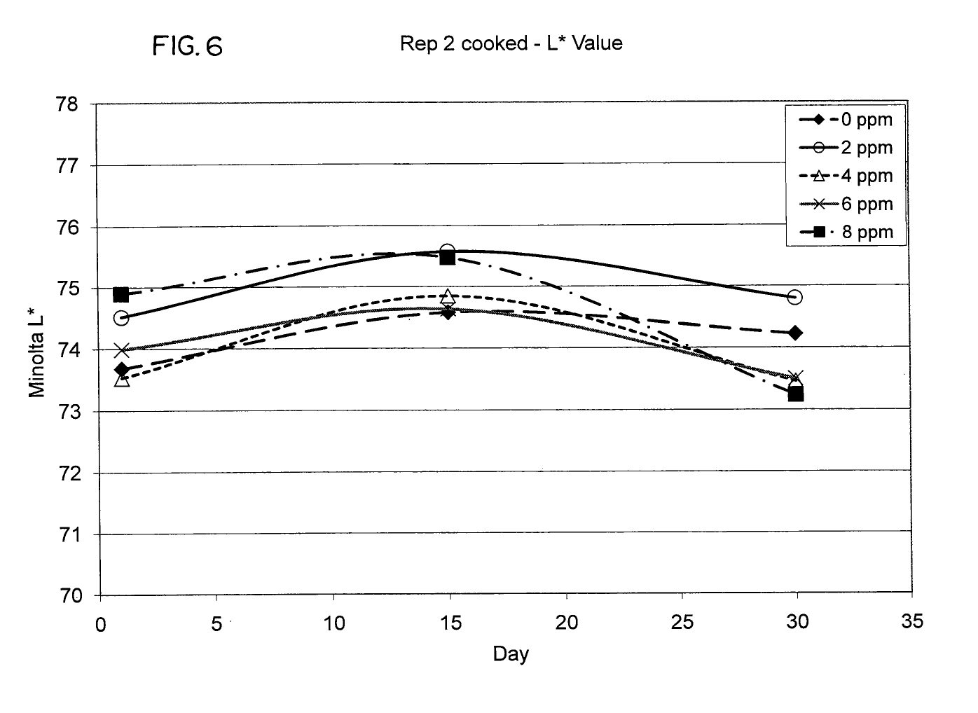

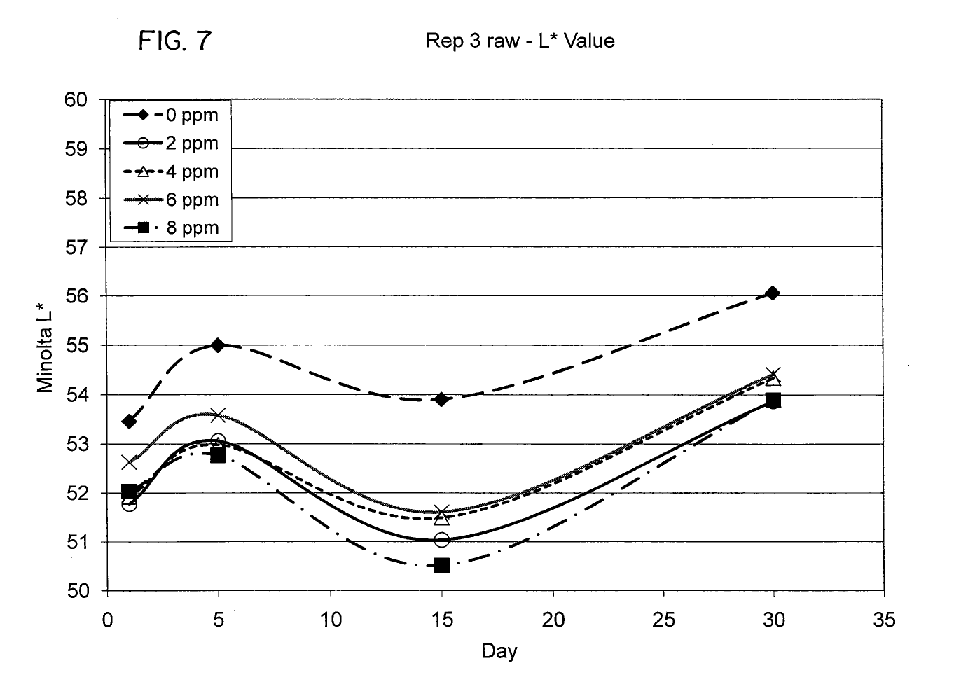

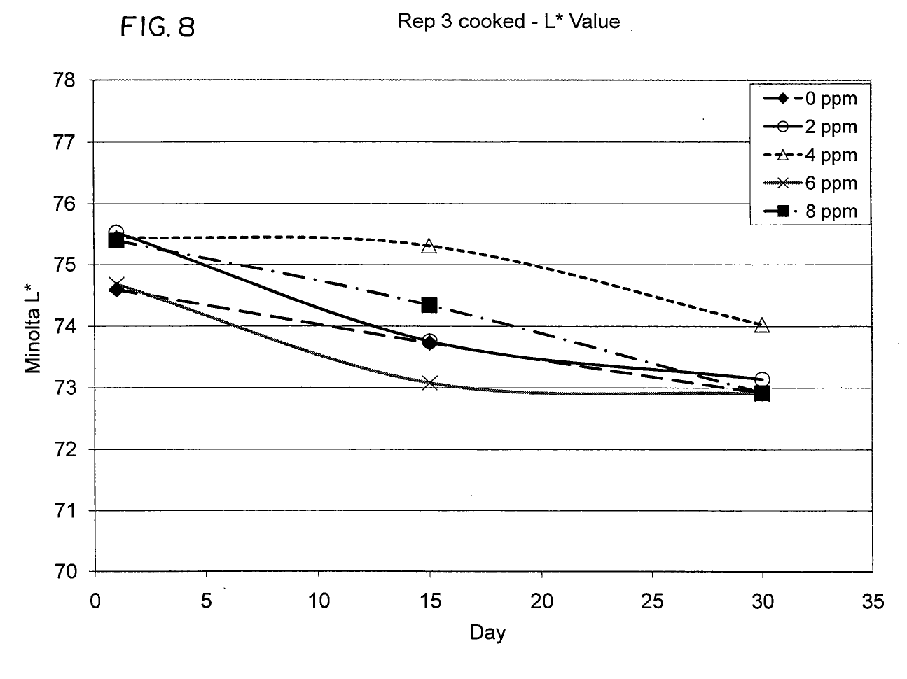

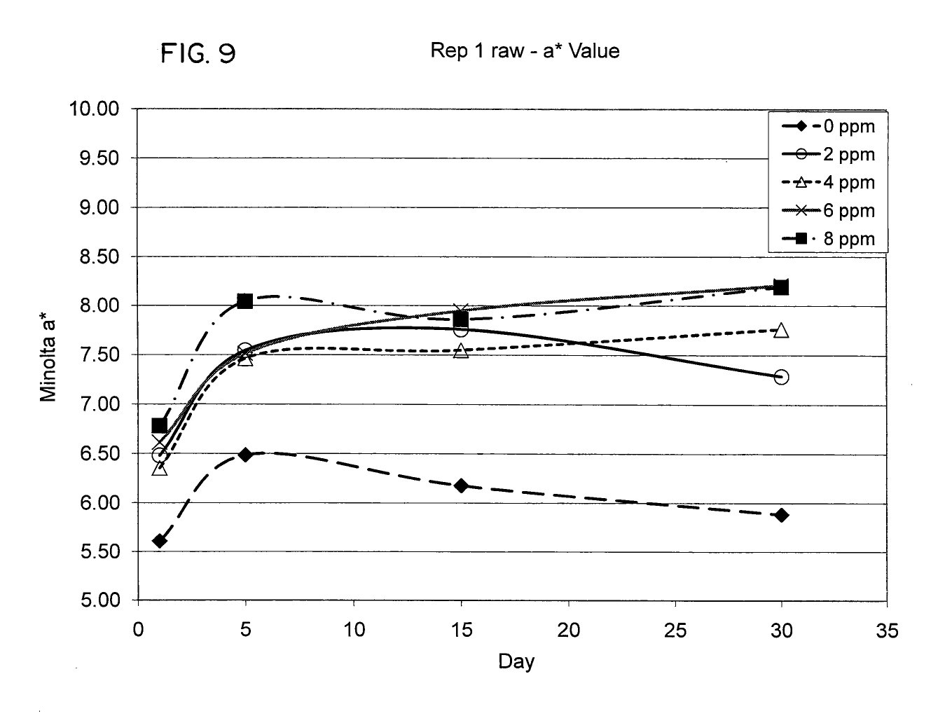

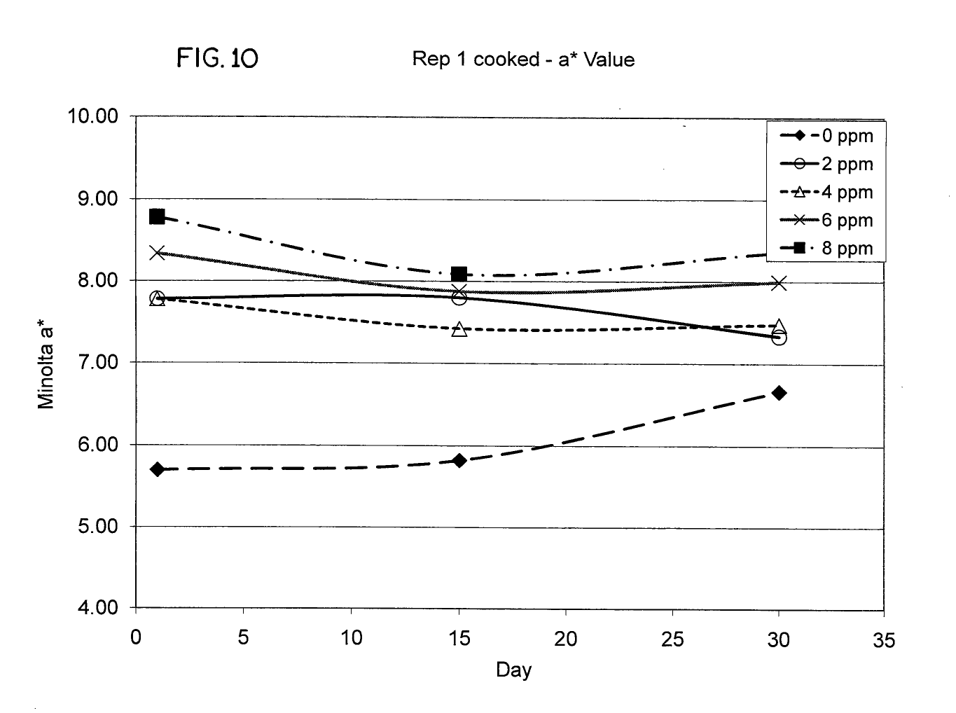

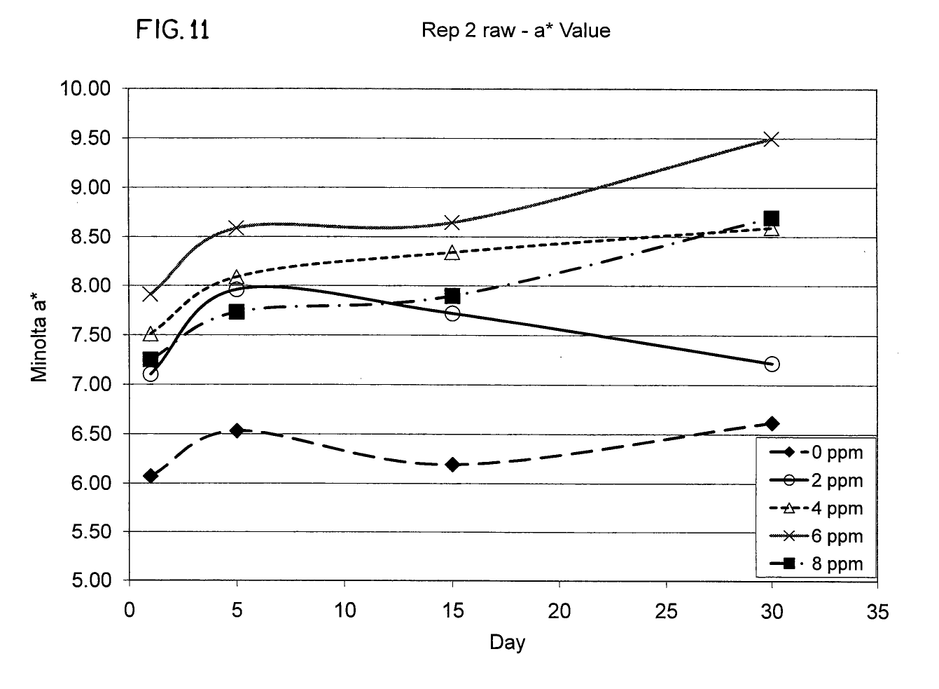

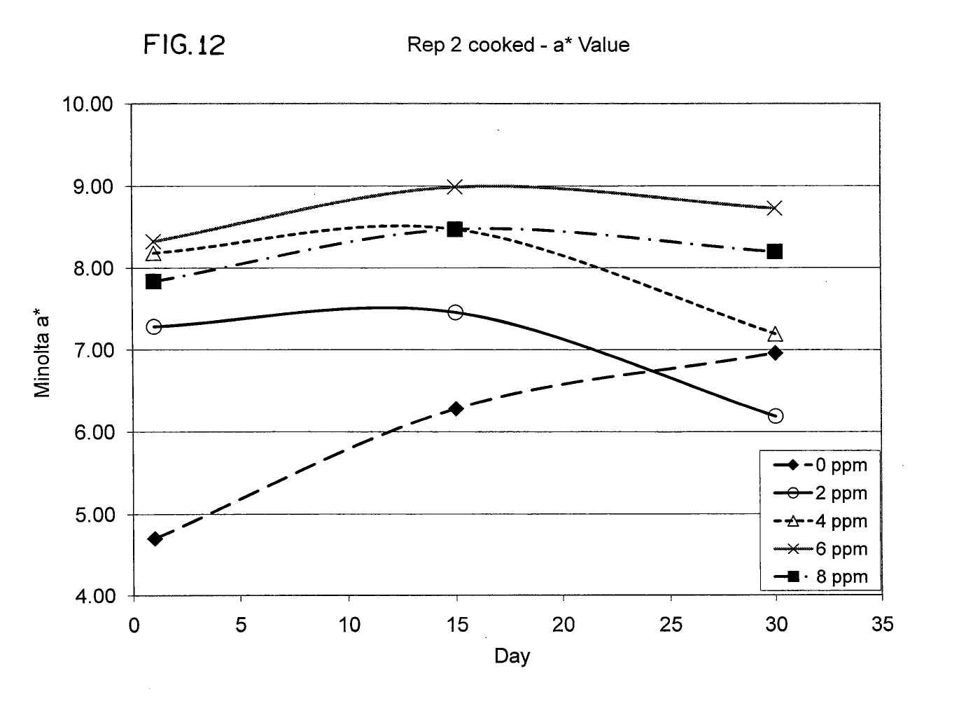

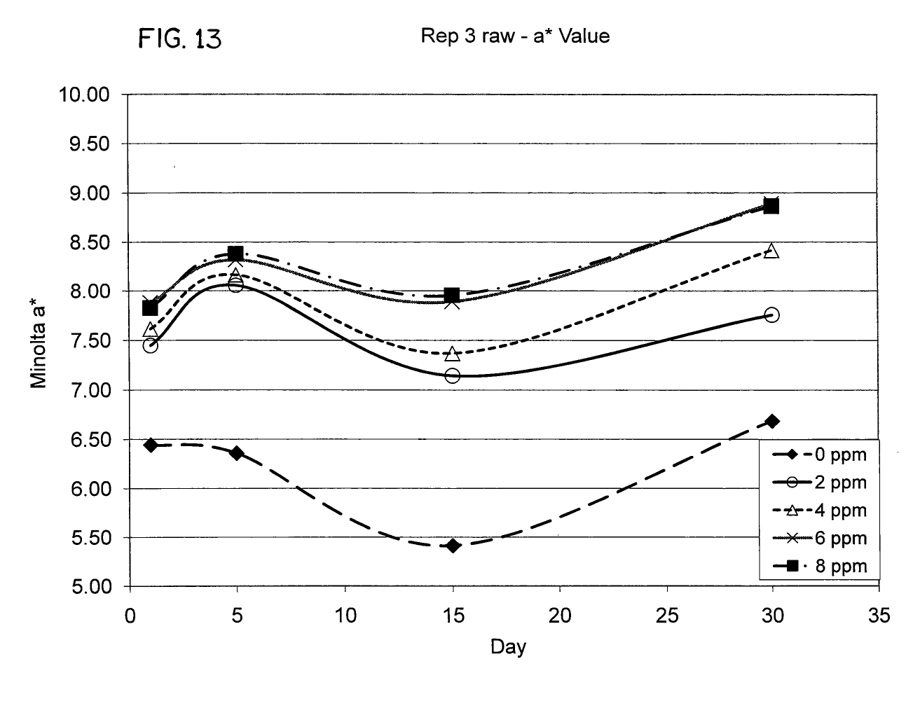

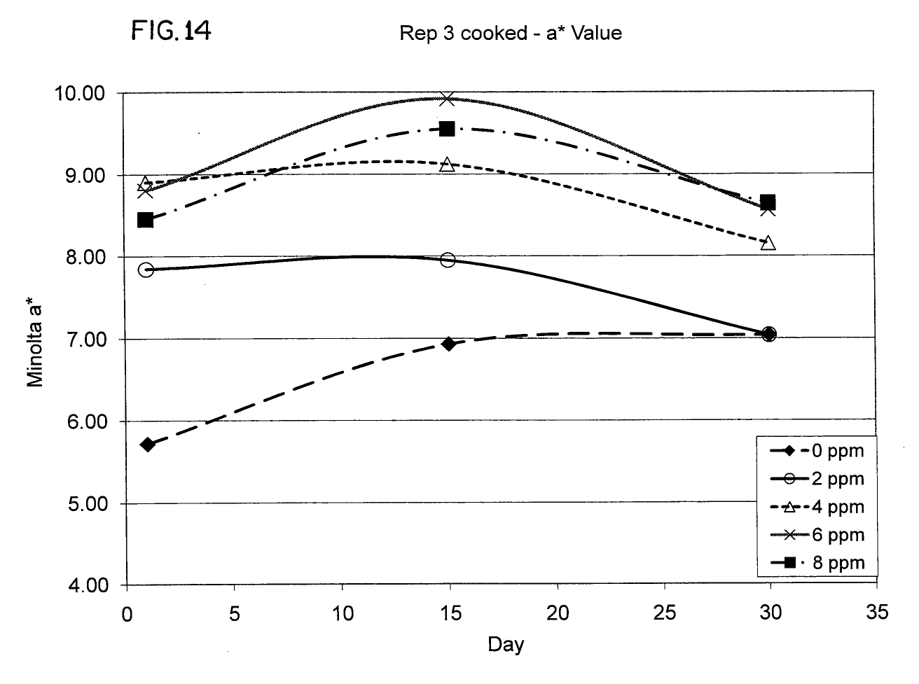

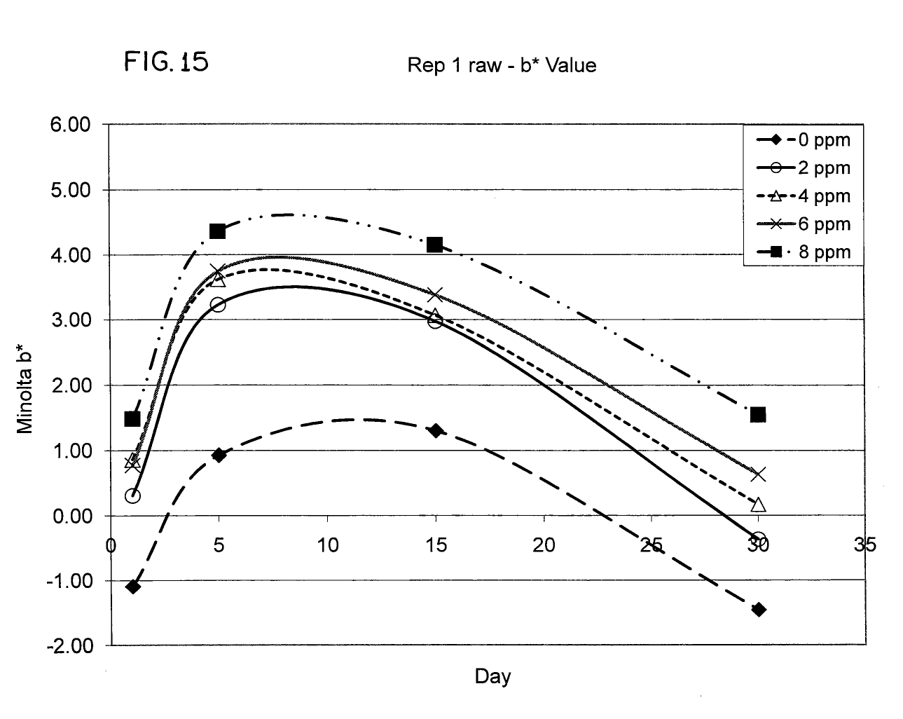

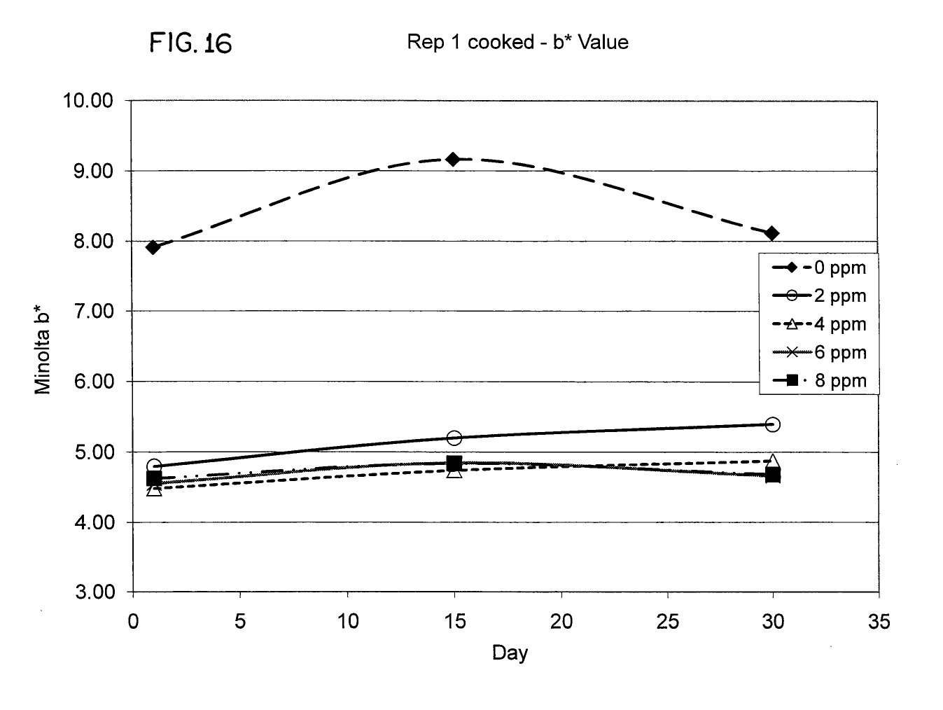

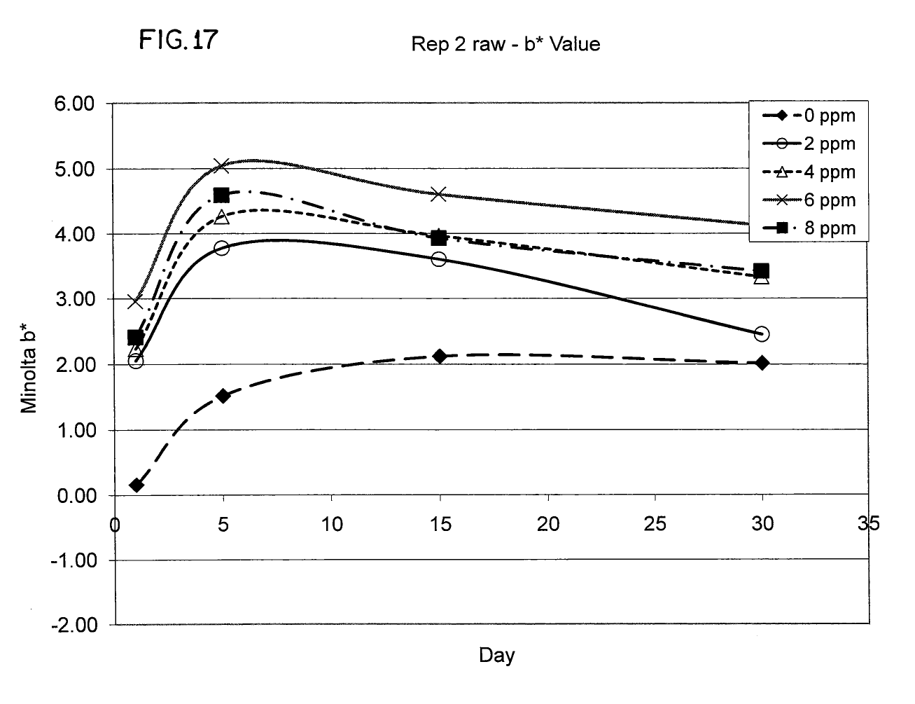

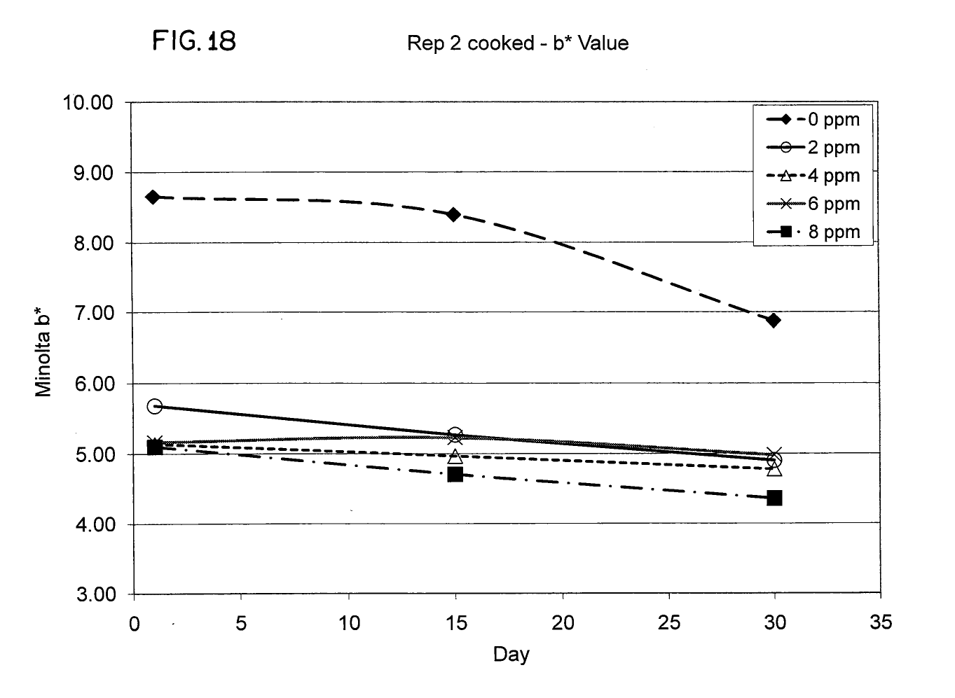

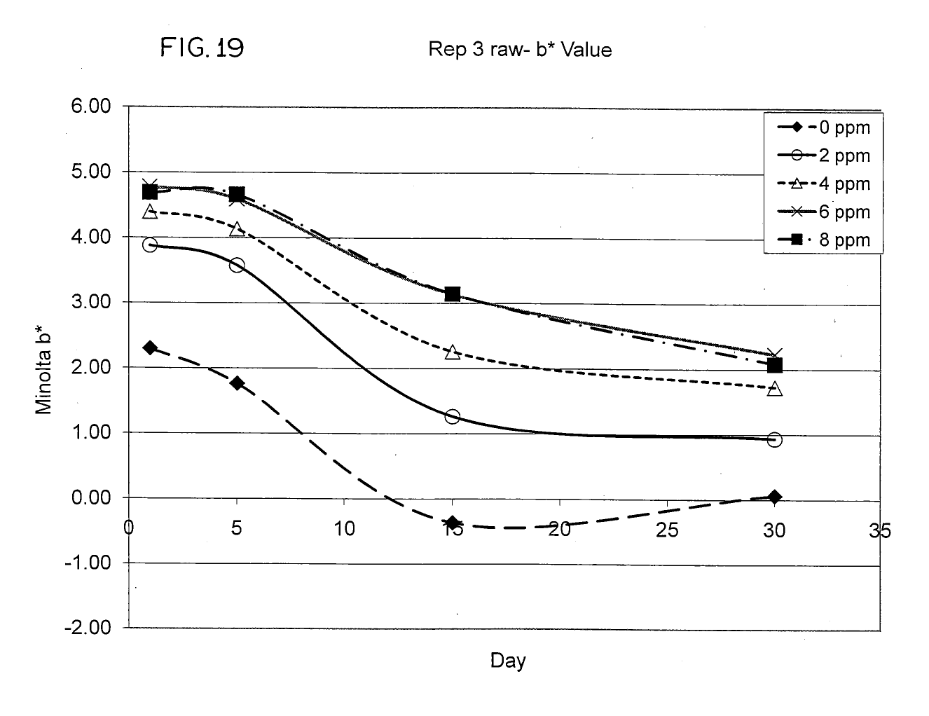

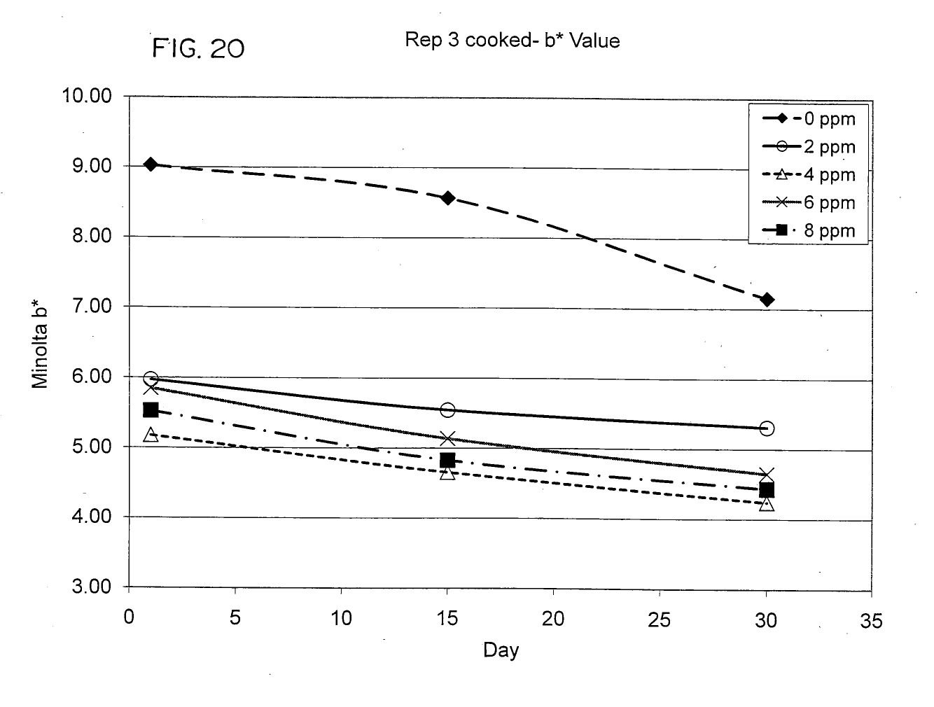

The chops were vacuum packaged within two hours after being injected. A Konica Minolta CR-400 colorimeter (Illuminant D65) was standardized with the packaging film over the color standard. Three color measurements were taken on one randomly chosen chop from each treatment in the vacuum packaging on the cut surface at 1, 5, 15, and 30 days after being vacuum packaged. The color was measured on the side of the chop that was exposed to the light in the display case. A schematic view of a chop 14 and three possible locations 15 for color measurement are shown in FIG. 2.

Raw color was measured on days 1, 5, 15, and 30. Cooked color was measured on days 1, 15, and 30. On days 1, 15, and 30, one chop from each treatment was kept in the vacuum packaging and heated at 180±2° F. for 15 minutes, and three color measurements were taken on the cooked chop on the side that was exposed to the light in the display case. Because the chops were cooked in the vacuum packaging, the chops did not brown as they would if they were cooked without the vacuum packaging. Therefore, the color scores were different than if the chops had been cooked without the vacuum packaging. The averages of these three measurements were calculated and compared over time.

The Minolta color scores for L*, a*, and b* raw and cooked for each Replicate Experiment are as follows in Tables 8-13:

TABLE 8
Minolta Color Scores for L* Raw

| ppm | | | | |
|---|---|---|---|---|
| Nitrite | Data | 1 | 2 | 3 |
| 0 | Average of Day1 L* raw | 51.70 | 53.91 | 53.46 |
| 0 | Average of Day5 L* raw | 51.85 | 53.92 | 55.00 |
| 0 | Average of Day15 L* raw | 53.69 | 56.05 | 53.91 |
| 0 | Average of Day30 L* raw | 54.31 | 57.40 | 56.06 |
| 2 | Average of Day1 L* raw | 50.41 | 53.35 | 51.77 |
| 2 | Average of Day5 L* raw | 52.80 | 53.65 | 53.06 |
| 2 | Average of Day15 L* raw | 52.84 | 55.75 | 51.04 |
| 2 | Average of Day30 L* raw | 52.72 | 57.05 | 53.87 |
| 4 | Average of Day1 L* raw | 51.72 | 52.54 | 51.92 |
| 4 | Average of Day5 L* raw | 53.69 | 52.93 | 52.98 |
| 4 | Average of Day15 L* raw | 53.95 | 54.75 | 51.49 |
| 4 | Average of Day30 L* raw | 53.64 | 56.13 | 54.34 |
| 6 | Average of Day1 L* raw | 50.88 | 52.86 | 52.63 |
| 6 | Average of Day5 L* raw | 53.24 | 53.38 | 53.58 |
| 6 | Average of Day15 L* raw | 52.61 | 55.17 | 51.61 |
| 6 | Average of Day30 L* raw | 52.63 | 56.34 | 54.42 |
| 8 | Average of Day1 L* raw | 52.11 | 52.44 | 52.03 |
| 8 | Average of Day5 L* raw | 53.16 | 53.33 | 52.77 |
| 8 | Average of Day15 L* raw | 54.30 | 54.78 | 50.51 |
| 8 | Average of Day30 L* raw | 54.14 | 55.95 | 53.89 |

TABLE 9
Minolta Color Scores for L* Cooked

| ppm | | | | |
|---|---|---|---|---|
| Nitrite | Data | 1 | 2 | 3 |
| 0 | Average of Day1 L* cooked | 74.73 | 73.68 | 74.59 |
| 0 | Average of Day15 L* cooked | 74.12 | 74.58 | 73.73 |
| 0 | Average of Day30 L* cooked | 73.71 | 74.22 | 72.91 |
| 2 | Average of Day1 L* cooked | 75.96 | 74.51 | 75.53 |
| 2 | Average of Day15 L* cooked | 74.40 | 75.58 | 73.76 |
| 2 | Average of Day30 L* cooked | 74.06 | 74.80 | 73.14 |
| 4 | Average of Day1 L* cooked | 76.31 | 73.53 | 75.45 |
| 4 | Average of Day15 L* cooked | 74.34 | 74.85 | 75.31 |
| 4 | Average of Day30 L* cooked | 75.42 | 73.46 | 74.03 |
| 6 | Average of Day1 L* cooked | 76.35 | 73.99 | 74.68 |
| 6 | Average of Day15 L* cooked | 74.84 | 74.63 | 73.08 |
| 6 | Average of Day30 L* cooked | 75.27 | 73.50 | 72.91 |
| 8 | Average of Day1 L* cooked | 75.21 | 74.89 | 75.40 |
| 8 | Average of Day15 L* cooked | 73.86 | 75.48 | 74.34 |
| 8 | Average of Day30 L* cooked | 74.41 | 73.24 | 72.92 |

TABLE 10
Minolta Color Scores for a* Raw

| ppm | | | | |
|---|---|---|---|---|
| Nitrite | Data | 1 | 2 | 3 |
| 0 | Average of Day1 a* raw | 5.61 | 6.07 | 6.44 |
| 0 | Average of Day5 a* raw | 6.49 | 6.53 | 6.36 |
| 0 | Average of Day15 a* raw | 6.18 | 6.19 | 5.41 |
| 0 | Average of Day30 a* raw | 5.88 | 6.62 | 6.69 |
| 2 | Average of Day1 a* raw | 6.48 | 7.10 | 7.45 |
| 2 | Average of Day5 a* raw | 7.54 | 7.96 | 8.06 |
| 2 | Average of Day15 a* raw | 7.76 | 7.72 | 7.14 |
| 2 | Average of Day30 a* raw | 7.29 | 7.22 | 7.76 |
| 4 | Average of Day1 a* raw | 6.35 | 7.51 | 7.62 |
| 4 | Average of Day5 a* raw | 7.46 | 8.09 | 8.17 |
| 4 | Average of Day15 a* raw | 7.55 | 8.34 | 7.37 |
| 4 | Average of Day30 a* raw | 7.76 | 8.59 | 8.42 |
| 6 | Average of Day1 a* raw | 6.61 | 7.91 | 7.88 |
| 6 | Average of Day5 a* raw | 7.51 | 8.59 | 8.32 |
| 6 | Average of Day15 a* raw | 7.95 | 8.65 | 7.89 |
| 6 | Average of Day30 a* raw | 8.21 | 9.50 | 8.89 |
| 8 | Average of Day1 a* raw | 6.78 | 7.25 | 7.83 |
| 8 | Average of Day5 a* raw | 8.04 | 7.73 | 8.38 |
| 8 | Average of Day15 a* raw | 7.86 | 7.90 | 7.96 |
| 8 | Average of Day30 a* raw | 8.19 | 8.70 | 8.87 |

TABLE 11
Minolta Color Scores for a* Cooked

| ppm | | | | |
|---|---|---|---|---|
| Nitrite | Data | 1 | 2 | 3 |
| 0 | Average of Day1 a* cooked | 5.70 | 4.71 | 5.72 |
| 0 | Average of Day15 a* cooked | 5.82 | 6.28 | 6.93 |
| 0 | Average of Day30 a* cooked | 6.66 | 6.96 | 7.04 |
| 2 | Average of Day1 a* cooked | 7.78 | 7.28 | 7.84 |
| 2 | Average of Day15 a* cooked | 7.80 | 7.45 | 7.95 |
| 2 | Average of Day30 a* cooked | 7.33 | 6.19 | 7.04 |
| 4 | Average of Day1 a* cooked | 7.78 | 8.19 | 8.91 |
| 4 | Average of Day15 a* cooked | 7.42 | 8.47 | 9.13 |
| 4 | Average of Day30 a* cooked | 7.47 | 7.19 | 8.16 |
| 6 | Average of Day1 a* cooked | 8.34 | 8.33 | 8.81 |
| 6 | Average of Day15 a* cooked | 7.88 | 8.99 | 9.92 |
| 6 | Average of Day30 a* cooked | 8.00 | 8.73 | 8.57 |
| 8 | Average of Day1 a* cooked | 8.78 | 7.84 | 8.45 |
| 8 | Average of Day15 a* cooked | 8.09 | 8.47 | 9.55 |
| 8 | Average of Day30 a* cooked | 8.36 | 8.20 | 8.64 |

TABLE 12
Minolta Color Scores for b* Raw

| ppm | | | | |
|---|---|---|---|---|
| Nitrite | Data | 1 | 2 | 3 |
| 0 | Average of Day1 b* raw | −1.09 | 0.16 | 2.30 |
| 0 | Average of Day5 b* raw | 0.93 | 1.52 | 1.77 |
| 0 | Average of Day15 b* raw | 1.30 | 2.12 | −0.37 |
| 0 | Average of Day30 b* raw | −1.46 | 2.02 | 0.06 |
| 2 | Average of Day1 b* raw | 0.31 | 2.05 | 3.88 |
| 2 | Average of Day5 b* raw | 3.23 | 3.78 | 3.58 |
| 2 | Average of Day15 b* raw | 2.97 | 3.60 | 1.26 |
| 2 | Average of Day30 b* raw | −0.37 | 2.45 | 0.94 |
| 4 | Average of Day1 b* raw | 0.86 | 2.23 | 4.40 |
| 4 | Average of Day5 b* raw | 3.62 | 4.26 | 4.14 |
| 4 | Average of Day15 b* raw | 3.07 | 3.97 | 2.26 |
| 4 | Average of Day30 b* raw | 0.17 | 3.33 | 1.73 |
| 6 | Average of Day1 b* raw | 0.78 | 2.96 | 4.78 |
| 6 | Average of Day5 b* raw | 3.75 | 5.04 | 4.60 |
| 6 | Average of Day15 b* raw | 3.38 | 4.61 | 3.14 |
| 6 | Average of Day30 b* raw | 0.64 | 4.13 | 2.23 |
| 8 | Average of Day1 b* raw | 1.49 | 2.41 | 4.69 |
| 8 | Average of Day5 b* raw | 4.36 | 4.60 | 4.66 |
| 8 | Average of Day15 b* raw | 4.15 | 3.93 | 3.15 |
| 8 | Average of Day30 b* raw | 1.55 | 3.42 | 2.08 |

TABLE 13
Minolta Color Scores for b* Cooked

| ppm | | | | |
|---|---|---|---|---|
| Nitrite | Data | 1 | 2 | 3 |
| 0 | Average of Day1 b* cooked | 7.91 | 8.66 | 9.03 |
| 0 | Average of Day15 b* cooked | 9.17 | 8.40 | 8.57 |
| 0 | Average of Day30 b* cooked | 8.11 | 6.88 | 7.15 |
| 2 | Average of Day1 b* cooked | 4.80 | 5.68 | 5.97 |
| 2 | Average of Day15 b* cooked | 5.20 | 5.27 | 5.54 |
| 2 | Average of Day30 b* cooked | 5.40 | 4.90 | 5.31 |
| 4 | Average of Day1 b* cooked | 4.48 | 5.14 | 5.18 |
| 4 | Average of Day15 b* cooked | 4.74 | 4.97 | 4.66 |
| 4 | Average of Day30 b* cooked | 4.88 | 4.78 | 4.24 |
| 6 | Average of Day1 b* cooked | 4.56 | 5.16 | 5.85 |
| 6 | Average of Day15 b* cooked | 4.85 | 5.23 | 5.14 |
| 6 | Average of Day30 b* cooked | 4.67 | 4.98 | 4.65 |
| 8 | Average of Day1 b* cooked | 4.63 | 5.10 | 5.53 |
| 8 | Average of Day15 b* cooked | 4.84 | 4.71 | 4.83 |
| 8 | Average of Day30 b* cooked | 4.68 | 4.36 | 4.43 |

From this test, it was confirmed that low levels of product, when injected into pork as part of a solution, stabilize the color when the injected pork is vacuum packaged, and the injected pork maintains a fresh appearance in the vacuum package compared to untreated pork which appears “grayish” in color when vacuum packaged.

From the tests conducted in Examples 1-4, it was determined that low levels of sodium nitrite or sodium nitrate or natural sources of sodium nitrite or sodium nitrate, levels below detectable amounts, stabilize or enhance the appearance of fresh meat products through active binding of myoglobin pigments. This provides a fresh pink or red meat color in a variety of meats and packaging applications.

The level of sodium nitrite or sodium nitrate or natural sources of sodium nitrite or sodium nitrate that should be used depends upon the amount of myoglobin in the meat, which could depend upon the type of meat, the quality of the meat, the cut of meat, the age of the animal, and other factors well known in the art. For meat with more myoglobin, more sodium nitrite or sodium nitrate or natural sources of sodium nitrite or sodium nitrate should be used. For meat with less myoglobin, less sodium nitrite or sodium nitrate or natural sources of sodium nitrite or sodium nitrate should be used. In packaging containing little to no oxygen, the sodium nitrite or sodium nitrate infused into the meat stabilizes the myoglobin color, which results in a fresh meat color before cooking and a uniform, uncured cooked color after cooking to done. It is recognized that the uncured color of the meat depends upon the concentration of sodium nitrite or sodium nitrate in the treated meat.

The above specification, examples, and data provide a complete description of the manufacture and use of the composition of embodiments of the invention. Since many embodiments of the invention can be made without departing from the spirit and scope of the invention, the invention resides in the claims hereinafter appended.

We claim:

1. A packaged treated fresh meat product, comprising:
a fresh meat product;
a solution including a source of sodium nitrite or sodium nitrate infused into the fresh meat product to create a treated fresh meat product;
a low to no oxygen packaging containing the treated fresh meat product, wherein the treated fresh meat product has a fresh meat color before cooking and a uniform, uncured cooked color after cooking to done.

2. The packaged treated fresh meat product of claim 1, wherein the fresh meat product is selected from the group consisting of a pork product, a beef product, a poultry product, a lamb product, a fish product, and a seafood product.

3. The packaged treated fresh meat product of claim 1, wherein the solution further comprises water, salt, sodium tri-polyphosphate, potassium lactate, and sodium diacetate.

4. The packaged treated fresh meat product of claim 1, wherein the source of sodium nitrite or sodium nitrate is a natural source.

5. The packaged treated fresh meat product of claim 1, wherein the solution is injected into the fresh meat product.

6. The packaged treated fresh meat product of claim 1, wherein the treated fresh meat product is vacuum tumbled for 5 to 30 minutes at 1 to 30 rpm under a vacuum of 15 to 30 inches Hg.

7. The packaged treated fresh meat product of claim 1, wherein the fresh meat product is a pork product and the solution includes 0.1 to 10.0 ppm of the source of sodium nitrite or sodium nitrate.

8. The packaged treated fresh meat product of claim 7, wherein the solution includes 2.0 to 5.0 ppm of the source of sodium nitrite or sodium nitrate.

9. The packaged treated fresh meat product of claim 1, wherein the fresh meat product is a beef product and the solution includes 1.0 to 20.0 ppm of the source of sodium nitrite or sodium nitrate.

10. The packaged treated fresh meat product of claim 9, wherein the solution includes 2.0 to 10.0 ppm of the source of sodium nitrite or sodium nitrate.

11. The packaged treated fresh meat product of claim 1, wherein the packaging is selected from the group consisting of vacuum packaging and modified atmosphere packaging.

12. The packaged treated fresh meat product of claim 11, wherein the packaging includes 0% to 1.0% oxygen.

13. A packaged treated fresh pork product, comprising:
a fresh pork product;
a solution including a source of sodium nitrite or sodium nitrate infused into the fresh pork product to create a treated fresh pork product, the solution including 0.1 to 10.0 ppm of the source of sodium nitrite or sodium nitrate;
a low to no oxygen packaging containing the treated fresh pork product, wherein the treated fresh pork product has a fresh meat color before cooking and a uniform, uncured cooked color after cooking to done.

14. The packaged treated fresh pork product of claim 13, wherein the source of sodium nitrite or sodium nitrate is a natural source.

15. The packaged treated fresh pork product of claim 13, wherein the solution is injected into the fresh pork product.

16. The packaged treated fresh pork product of claim 13, wherein the treated fresh pork product is vacuum tumbled for 5 to 30 minutes at 1 to 30 rpm under a vacuum of 15 to 30 inches Hg.

17. The packaged treated fresh pork product of claim 13, wherein the packaging is selected from the group consisting of vacuum packaging and modified atmosphere packaging.

18. The packaged treated fresh pork product of claim 17, wherein the packaging includes 0% to 1.0% oxygen.

19. A packaged treated fresh beef product, comprising:
a fresh beef product;
a solution including a source of sodium nitrite or sodium nitrate infused into the fresh beef product to create a treated fresh beef product, the solution including 1.0 to 20.0 ppm of the source of sodium nitrite or sodium nitrate;
a low to no oxygen packaging containing the treated fresh beef product, wherein the treated fresh beef product has a fresh meat color before cooking and a uniform, uncured cooked color after cooking to done.

20. The packaged treated fresh beef product of claim 19, wherein the source of sodium nitrite or sodium nitrate is a natural source.

21. The packaged treated fresh beef product of claim 19, wherein the solution is injected into the fresh beef product.

22. The packaged treated fresh beef product of claim 19, wherein the treated fresh beef product is vacuum tumbled for 5 to 30 minutes at 1 to 30 rpm under a vacuum of 15 to 30 inches Hg.

23. The packaged treated fresh beef product of claim 19, wherein the packaging is selected from the group consisting of vacuum packaging and modified atmosphere packaging.

24. The packaged treated fresh beef product of claim 23, wherein the packaging includes 0% to 1.0% oxygen.

25. A method of treating a fresh meat product, comprising:
obtaining a fresh meat product selected from the group consisting of a pork product, a beef product, a poultry product, a lamb product, a fish product, and a seafood product;
infusing the fresh meat product with a solution including a source of sodium nitrite or sodium nitrate to create a treated fresh meat product; and
packaging the treated fresh meat product in a low to no oxygen packaging, wherein the treated fresh meat product has a fresh meat color before cooking and a uniform, uncured cooked color after cooking to done.

26. The method of claim 25, wherein the fresh meat product is infused by injection.

27. The method of claim 25, wherein the source of sodium nitrite or sodium nitrate is a natural source.

28. The method of claim 25, further comprising tumbling the treated fresh meat product under a vacuum of 15 to 30 inches Hg for 5 to 30 minutes at 1 to 30 rpm.

29. The method of claim 25, wherein the fresh meat product is a pork product and the solution includes 0.1 to 10.0 ppm of the source of sodium nitrite or sodium nitrate.

30. The method of claim 25, wherein the fresh meat product is a beef product and the solution includes 1.0 to 20.0 ppm of the source of sodium nitrite or sodium nitrate.

31. The method of claim 25, wherein the packaging is selected from the group consisting of vacuum packaging and modified atmosphere packaging including 0% to 1.0% oxygen.
